(19) United States
(12) Patent Application Publication
(10) Pub. No.: US 2018/0240137 A1
(43) Pub. Date: Aug. 23, 2018

(54) SYSTEM AND METHOD FOR FORECASTING ECONOMIC TRENDS USING STATISTICAL ANALYSIS OF WEATHER DATA

(71) Applicant: Accuweather, Inc., State College, PA (US)

(72) Inventors: Rosemary Yeilding Radich, Wichita, KS (US); Jennifer Bowers Akers, Wichita, KS (US); Tim Loftus, Wichita, KS (US); Michael R. Root, Edmond, OK (US)

(21) Appl. No.: 15/900,574

(22) Filed: Feb. 20, 2018

Related U.S. Application Data
(60) Provisional application No. 62/460,596, filed on Feb. 17, 2017.

(51) Int. Cl. G06Q 30/02; G06F 17/18; G06N 3/08

(52) U.S. Cl. CPC G06Q 30/0202; G06N 3/08; G06F 17/18

(57) ABSTRACT

Disclosed is an economic forecast system that overcomes technical problems with conventional systems. Conventional economic forecast systems may analyze past economic behavior and construct statistical models to predict future behavior. When incorporating past weather data, however, conventional systems generate overfitted and/or underfitted models because of the high multicollinearity of weather metrics. The disclosed system overcomes this technical problem with conventional systems by analyzing weather metrics that are divided into groups (based on the multicollinearity of the weather metrics in each group) and generates a statistical model using the one or more most statistically significant weather metrics from each group.

### BACKGROUND

Macro- and micro-economic trends, from infrastructure availability to energy consumption, are often affected by weather. Similarly, human behavior is often (consciously or subconsciously) affected by weather. Accordingly, businesses and other organizations seek accurate forecasts to predict everything from overall economic trends to demand for specific products.

Conventional economic forecasting systems analyze past economic behavior and construct economic forecasting models to predict future economic behavior. Weather databases include historical weather data that may be correlated with past events. Accordingly, some conventional economic forecasting systems may incorporate past weather data and model economic behavior as a function of weather conditions so as to predict future economic behavior in view of forecasted weather and climate conditions.

Conventional economic forecasting systems model an economic metric of interest by analyzing all of the available metrics that may be correlated with that economic metric of interest, determining the metrics where the correlation to the economic metric of interest, and generating a model that forecasts the economic metric of interest as a function of all of the metrics with a statistically significant correlation to the economic metric of interest.

However, conventional systems are poorly constructed to model past events based on past weather metrics because of the multicollinearity of past weather metrics. Multicollinearity is a phenomenon that occurs when two or more metrics are moderately or highly correlated with one another. In the fields of meteorology and climate science, the number of weather metrics has increased substantially. The weather database currently available from AccuWeather Enterprise Solutions of State College, Pa., for example, includes more than 300 weather metrics, including first-order derivatives, second order derivatives, etc. Some of those additional weather metrics are more predictive of economic trends than simpler weather metrics that may be considered by simpler economic forecasting systems. However, with more than 300 available weather metrics, multicollinearity occurs frequently as some of those weather metrics are highly related measurements of the same phenomena. For example, the daily high temperature, low temperature, and average temperature are all different metrics. However, they are all highly correlated to each other as they are all measuring heat present in the atmosphere at a specific location on a specific day.

Because of the high multicollinearity of historical weather metrics, conventional economic forecasting systems generate overfitted models or underfitted models. Overfitting is the production of an analysis that corresponds too closely or exactly to a particular set of data and may therefore fail to reliably predict future observations. In essence, an overfitted model conforms to the residual variation (i.e., the noise) in the past data, which is not expected to occur in future data, leading to an inaccurate forecast. Underfitting occurs when a statistical model cannot adequately capture the underlying structure of the data. A simple example of underfitting is fitting a linear model to non-linear data, which would tend to have poor predictive performance. However, an underfitted model can be any model where some parameters or terms that would appear in a correctly specified model are missing.

Therefore, there is a need for an economic forecasting system that forecasts future economic trends based on forecasted weather metrics without developing an overfitted model or an underfitted model due to the high multicollinearity of historical weather metrics.

### SUMMARY

In order to overcome those and other technical problems with conventional forecasting systems, an economic forecasting system is provided that analyzes weather metrics that are divided into groups (based on the multicollinearity of the weather metrics in each group), identifies the most statistically significant weather metrics from each group, generates a statistical model using the one or more most statistically significant weather metrics from each group, receives forecasted weather metrics, and forecasts an economic performance metric of interest based on the statistical model and the forecasted weather metrics.

In contrast to the underfitted or overfitted models generated using conventional methods, analyzing weather metrics that are divided into groups based on the multicollinearity of those weather metrics causes the disclosed system to efficiently identify the weather metrics that are most predictive of the future economic trends, even using a large number of weather metrics that are computationally expensive to test.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a block diagram of an economic forecasting system according to an exemplary embodiment;

FIG. 2 is a flowchart illustrating an overview of the process for generating a model for an economic performance metric of interest, based on historical weather metrics, and generating a forecast for the economic performance metric of interest based on forecasted weather metrics according to an exemplary embodiment;

FIG. 3 is a block diagram illustrating the process for selecting the most statistically significant historical weather metrics from each group according to an exemplary embodiment;

FIG. 4 is a block diagram of an architecture 400 of the economic forecasting system 100 according to an exemplary embodiment;

FIG. 5 is a block diagram of another architecture 500 of the economic forecasting system 100 according to another exemplary embodiment; and

FIG. 6 is a block diagram of another architecture 600 of the economic forecasting system 100 according to another exemplary embodiment.

### DETAILED DESCRIPTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

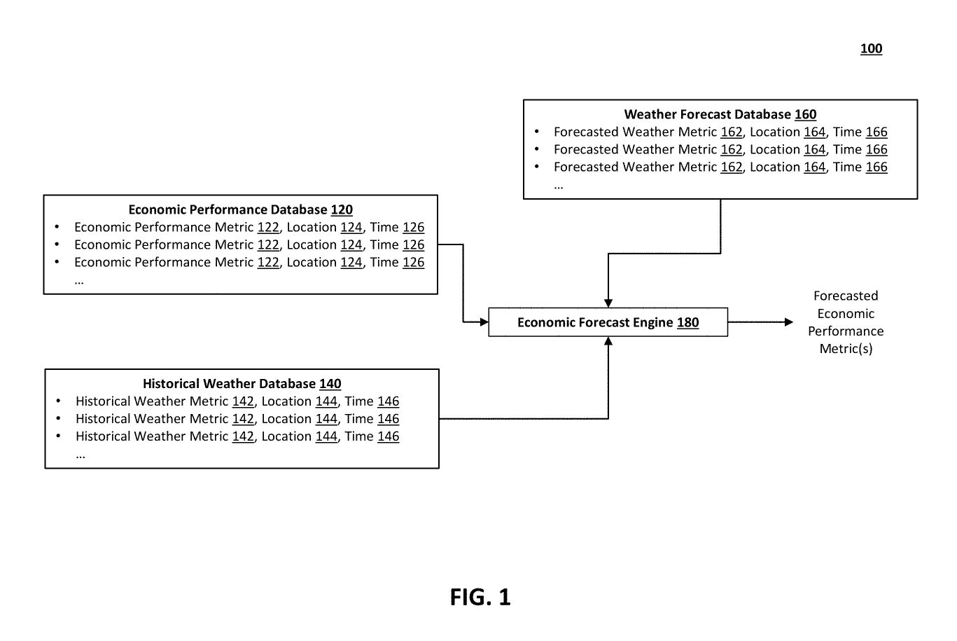

FIG. 1 is a block diagram of the economic forecasting system 100 according to an exemplary embodiment.

As shown in FIG. 1, the economic forecasting system 100 includes an economic performance database 120, a historical weather database 140, a weather forecast database 160, and an economic forecast engine 180.

The historical economic performance database 120 stores geo-located and time-indexed historical economic performance metrics 122. Each of the historical economic performance metrics 122 describe one or more events that took place at in a specific location 124 at a specific time 126. For each geo-located and time-indexed historical economic performance metric 122, the historical economic performance database 120 stores the magnitude of each metric 122, the location 124, and the time 126. The location 124 may be expressed as latitude and longitude, municipality (e.g., city, county, state, etc.), region, etc. The time 126 may be the date, the specific time of day on that date, etc.

The historical economic performance metrics 122 may include retail sales metrics (e.g., sales as dollars, point-of-sale quantities, counts of trends, sales of item by specific SKU numbers, etc.), infrastructure metrics (e.g., location availability, power outages, etc.), commodities metrics (e.g., energy usage, demand for other commodities), human resources metrics (e.g., employee availability), etc.

The historical economic performance metrics 122 may be received from third party sources, including governmental sources, such as the U.S. National Oceanic and Atmospheric Administration (NOAA), the U.S. National Aeronautics and Space Administration (NASA), the U.S. Health Resources & Services Administration (HRSA), the U.S. Bureau of Economic Analysis (BEA), and the U.S. Bureau of Labor Statistics (BLS), as well as private sources of economic data, such as Drought Monitor, the National Snow and Ice Data Center (NSIDC), ESRI Marketplace data, the Cornell Institute for Social and Economic Research (CISER), TWITTER and FACEBOOK data, financial market data, and power outage data. (FACEBOOK is a trademark of Facebook, Inc. TWITTER is a trademark of Twitter, Inc.) Most often, however, the economic forecasting system 100 is used to forecast economic trends for a specific client based on historical economic performance metrics 122 received from that client.

The historical weather database 140 stores geo-located and time-indexed historical weather metrics 142. Again, each of the geo-located and time-indexed historical weather metrics 142 describe a weather or environmental condition in a specific location 144 at a specific time 146. For each geo-located and time-indexed historical weather metric 142, the historical weather database 140 stores the magnitude of each metric 142, the location 144, and the time 146. The location 144 may be expressed as latitude and longitude, municipality (e.g., city, county, state, etc.), region, etc. The time 146 may be the date, the specific time of day on that date, etc.

The historical weather metrics 142 may include temperature metrics, including highest temperature, lowest temperature, average daily temperature (all hours), highest temperature departure from normal, lowest temperature departure from normal, average daily temperature departure from normal, average daily temperature (highest/lowest), etc.; Dew point, relative humidity, soil temperature and moisture metrics, including maximum dew point temperature, minimum dew point temperature, average dew point temperature, maximum relative humidity, minimum relative humidity, average relative humidity, maximum wet bulb temperature, minimum wet bulb temperature, average wet bulb temperature, soil moisture, etc.; Atmospheric pressure metrics, including highest pressure, lowest pressure, average pressure, etc.; Cooling, heating, effective, growing, and freezing degree days metrics, including cooling degree days, heating degree days, effective degree days, growing degree days, freezing degree days, etc.; Wind metrics, including highest sustained wind speed, lowest sustained wind speed, average sustained wind speed, highest wind gust, etc.; Solar irradiance metrics, including maximum solar radiance, minimum solar radiance, average solar radiance, total solar radiance, etc.; Sunshine metrics, including total minutes of sunshine, minutes of sunshine possible, percent of sunshine possible, etc.; Precipitation metrics, including observed daily water equivalent, percent of normal daily water equivalent, etc.; Snow, freeze, ice, and sleet metrics, including snowfall, snow at 0.50 inches, snow on ground, snow within 35 miles, etc.; Spring, tropical storms, hurricane, and visibility metrics, including average visibility, visibility at 0.50 miles, visibility at 2.00 miles, etc. The historical weather metrics 142 may include first-order derivatives, second order derivatives, etc. The historical weather metrics 142 may include proprietary weather metrics, such as the average daily REALFEEL temperature, the maximum daily REALFEEL temperature, the minimum daily REALFEEL temperature, etc. (REALFEEL is a registered service mark of AccuWeather, Inc.)

The historical weather metrics 142 may be received, for example, from AccuWeather, Inc., AccuWeather Enterprise Solutions, Inc., the National Weather Service (NWS), the National Hurricane Center (NHC), Environment Canada, other governmental agencies (such as the U.K. Meteorologic Service, the Japan Meteorological Agency, etc.), private companies (such as Vaisalia's U. S. National Lightning Detection Network, Weather Decision Technologies, Inc.), individuals (such as members of the Spotter Network), etc. The historical weather metrics 142 may also include information regarding environmental conditions received, for example, from the U.S. Environmental Protection Agency (EPA) and/or information regarding natural hazards (such as earthquakes) received, for example, from the U.S. Geological Survey (USGS).

The weather forecast database 160 stores forecasted weather metrics 162. The forecasted weather metrics 162 include forecasted weather and environmental conditions for specific locations 164 and specific times 166. The locations 164 may be expressed as latitude and longitude, municipality (e.g., city, county, state, etc.), region, etc. The times 166 may be the date, the specific time of day on that date, etc. The forecasted weather metrics 162 may be short term forecasted weather metrics, long term forecasted weather metrics, long term climatological metrics, etc.

The forecasted weather metrics 162 include the same weather metrics as the historical weather metrics 142 and may be received from the same sources. The economic forecasting system 100 may also include a weather forecasting engine (not shown) that generates some or all of the forecasted weather metrics 162, for example using one or more mathematical models of the atmosphere and oceans to predict future weather conditions based on current weather conditions.

The economic forecast engine 180 builds a statistical model for each economic performance metric 122 of interest based on correlations between the geo-located and time-indexed historical economic performance metric 122 of interest and the geo-located and time-indexed historical weather metrics 142. As described in detail below, the economic forecast engine 180 identifies historical weather metrics 142 that correlate with an historical economic performance metric 122 of interest, such that the model can be generated and used to forecast the economic performance metric 122 of interest based on the forecasted weather metrics 162.

Notably, the economic forecast engine 180 does not analyze all of the weather metrics 142 together or build a statistical model using all of the historical weather metrics 142 found to be statistically significant because, as described in the background of this disclosure, doing so would result in an overfitted or underfitted model, in part because of the multicollinearity of the historical weather metrics 142.

Instead, the economic forecast engine 180 separately analyzes groups of historical weather metrics 142 and identifies one or more of the most statistically significant historical weather metrics 142 in each group. Each group includes historical weather metrics 142 that have been grouped together based on their multicollinearity.

In one exemplary embodiment, the economic forecast engine 180 uses the following ten groups of historical weather metrics 142:
1. Temperature metrics
   a. Highest temperature
   b. Lowest temperature
   c. Average daily temperature (all hours)
   d. Highest temperature departure from normal
   e. Lowest temperature departure from normal
   f. Average daily temperature departure from normal
   g. Average daily temperature (highest/lowest)
   h. etc.
2. Dew point, relative humidity, soil temperature and moisture metrics
   a. Maximum dew point temperature
   b. Minimum dew point temperature
   c. Average dew point temperature
   d. Maximum relative humidity
   e. Minimum relative humidity
   f. Average relative humidity
   g. Maximum wet bulb temperature
   h. Minimum wet bulb temperature
   i. Average wet bulb temperature
   j. Soil moisture
   k. etc.
3. Atmospheric pressure metrics
   a. Highest pressure
   b. Lowest pressure
   c. Average daily pressure
   d. etc.
4. Cooling, heating, effective, growing, and freezing degree days metrics
   a. Cooling degree days
   b. Heating degree days
   c. Effective degree days
   d. Growing degree days
   e. Freezing degree days
   f. etc.
5. Wind metrics
   a. Maximum sustained wind speed
   b. Minimum sustained wind speed
   c. Average wind speed
   d. Highest wind gust
   e. etc.
6. Solar irradiance metrics
   a. Maximum solar radiance
   b. Minimum solar radiance
   c. Average solar radiance
   d. Total solar radiance
   e. etc.
7. Sunshine metrics
   a. Total minutes of sunshine
   b. Minutes of sunshine possible
   c. Percent of sunshine possible
   d. etc.
8. Precipitation metrics
   a. Observed daily water equivalent
   b. Percent of normal daily water equivalent
   c. etc.
9. Snow, freeze, ice, and sleet metrics
   a. Snowfall
   b. Snow at 0.50 inches
   c. Snow on ground
   d. Snow within 35 miles
   e. etc.
10. Spring, tropical storms, hurricane, and visibility metrics
   a. Average visibility
   b. Visibility at 0.50 miles
   c. Visibility at 2.00 miles
   d. etc.

The historical weather metrics 142 are segregated into groups (for example, as shown above) based on their multicollinearity. Specifically, the weather metrics 142 are segregated into groups such that the historical weather metrics 142 with the highest absolute Pearson correlation coefficient are in the same group. Table 1 shows rules of thumb when using Pearson correlation coefficients to determine multicollinearity.

TABLE 1

| Pearson | |
|---|---|
| Correlation | |
| Coefficient | Description |
| +1.00 | A perfect positive linear relationship |
| +0.70 | A strong positive linear relationship |
| +0.50 | A moderate positive linear relationship |
| +0.30 | A weak positive linear relationship |
| 0 | No linear relationship |
| −0.30 | A weak negative linear relationship |
| −0.50 | A moderate negative linear relationship |
| −0.70 | A strong negative linear relationship |
| −1.00 | A perfect negative linear relationship |

Table 2 shows a simplified example of separating historical weather metrics 142 into groups based on Pearson correlation coefficients, using only three temperature metrics (highest temperature, lowest temperature, and average temperature) and three wind metrics (highest wind speed, lowest wind speed, and average wind speed).

TABLE 2
Pearson Correlation Coefficients

| | Highest | Lowest | Average | Highest | Lowest | Average |
|---|---|---|---|---|---|---|
| | Temperature | Temperature | Temperature | Wind Speed | Wind Speed | Wind Speed |
| Highest Temperature | 1.00 | | | | | |
| Lowest Temperature | 0.91 | 1.00 | | | | |
| Average Temperature | 0.98 | 0.97 | 1.00 | | | |
| Highest Wind Speed | −0.09 | −0.08 | −0.08 | 1.00 | | |
| Lowest Wind Speed | −0.17 | −0.08 | −0.13 | 0.55 | 1.00 | |
| Average Wind Speed | −0.16 | −0.10 | −0.13 | 0.88 | 0.75 | 1.00 |

As shown in Table 2, the highest temperature, the lowest temperature, and the average temperature all have a strong (in this instance, positive) correlation with respect to each other and so are therefore grouped together (as temperature metrics). Similarly, the highest wind speed, the lowest wind speed, and the average wind speed all have moderate-to-strong (in this instance, positive) correlations with each other and so are therefore grouped together (as wind metrics). Conversely, none of the temperature metrics have even a week correlation (either positive or negative) with any of the wind metrics. Accordingly, the example temperature metrics and the example wind metrics are separated into different groups.

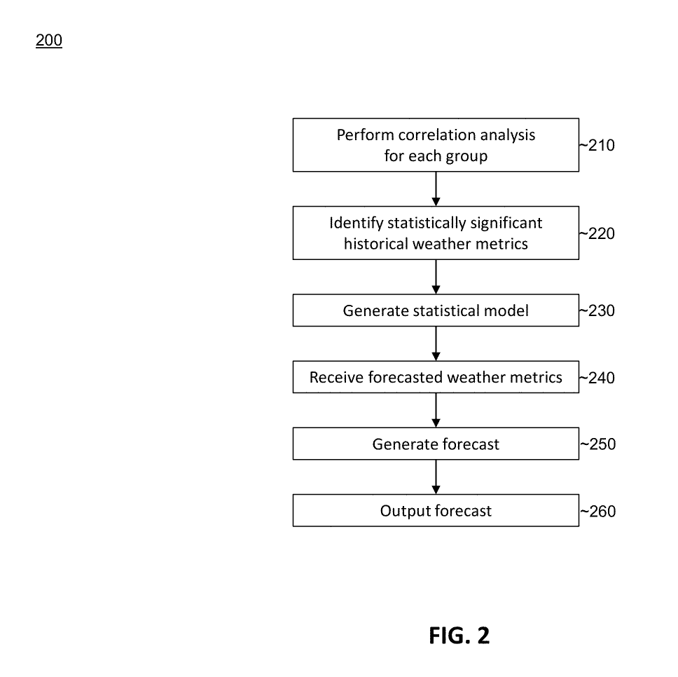

FIG. 2 is a flowchart illustrating an overview of the process 200 for generating a model for an economic performance metric 122 of interest, based on the historical weather metrics 142 that have been separated into groups as described above, and generating a forecast for the economic performance metric 122 of interest based on forecasted weather metrics 162 according to an exemplary embodiment. The process 200 is performed by the economic forecast engine 180 for each economic performance metric 122 of interest.

For each group of historical weather metrics 142, a correlation analysis is performed in step 210. The correlation analysis determines the Pearson correlation coefficient and statistical significance (e.g., probability value or “p-value”) of each historical weather metric 142 with respect to the economic performance metric 122 of interest.

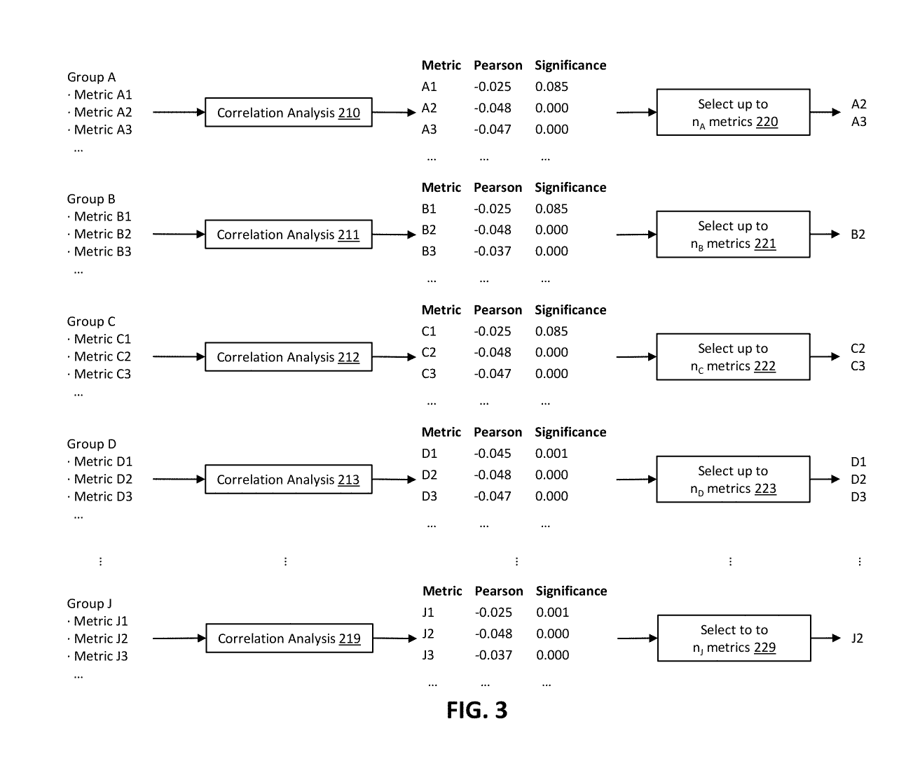

Up to a predetermined number of the most statistically significant historical weather metrics 142 are selected from each group of historical weather metrics 142 in step 220. The processes 210 and 220 for performing a correlation analysis and selecting the most statistically significant historical weather metrics 142 from each group is described in detail with reference to FIG. 3.

A statistical model is generated using the selected historical weather metrics 142 in step 230. The forecasting model may be generated using regression analysis (e.g., linear, logistic, best subsets, stepwise, etc.), decision trees (e.g., C5, CART, CHAID, etc.), neural networks (Multilayer Perceptron, Radial Basis Function, etc.) or other artificial intelligence, etc.

Forecasted weather metrics 162 are received in step 240.

A forecast for the economic performance metric 122 of interest is generated in step 250 based on the statistical model generated in step 230 and the forecasted weather metrics 162 received in step 240.

The forecasted generated in step 250 is output in step 260. The forecast may be output to a user via a graphical user interface. Additionally or alternatively, the forecast may be output to a communication network for transmittal to a client computing device (for example, the source of the economic performance metric 122 of interest).

FIG. 3 is a block diagram illustrating the processes 210 and 220 for determining and selecting the most statistically significant historical weather metrics 142 from each group according to an exemplary embodiment.

As shown in FIG. 3, each of the historical weather metrics 142 have been separated into groups. In this example, the historical weather metrics 142 have been separated into Groups A through J such that Group A includes metric A1, metric A2, etc., Group B includes metric B1, metric B2, etc.

For each group of historical weather metrics 142, a correlation analysis is performed to identify the Pearson correlation coefficient and statistical significance of each historical weather metric 142. Specifically, for Group A, a correlation analysis is performed in step 210 to identify the Pearson correlation coefficient and statistical significance of each of the historical weather metrics A1, A2, etc. in Group A with respect to the economic performance metric 122 of interest. Similarly, for Group B, a correlation analysis is performed in step 211 to identify the Pearson correlation coefficient and statistical significance of each of the historical weather metrics B1, B2, etc. in Group B with respect to the economic performance metric 122 of interest. A similar correlation analysis is performed in steps 212 through 219 for each of the historical weather metrics 142 in Groups C through J.

Table 3 shows an example identifying the Pearson correlation coefficients and statistical significance of seven temperature metrics (Group A in the example above).

TABLE 3

| | | |
|---|---|---|
| Highest temperature | Pearson Correlation Value | −0.025 |
| | Significance (p-value) | 0.000 |
| Lowest temperature | Pearson Correlation Value | −0.007 |
| | Significance (p-value) | 0.085 |
| Average daily temperature (all hours) | Pearson Correlation Value | −0.014 |
| | Significance (p-value) | 0.000 |
| Highest temperature departure from normal | Pearson Correlation Value | −0.048 |
| | Significance (p-value) | 0.000 |
| Lowest temperature departure from normal | Pearson Correlation Value | −0.036 |
| | Significance (p-value) | 0.000 |
| Average daily temperature departure from normal | Pearson Correlation Value | −0.047 |
| | Significance (p-value) | 0.000 |
| Average daily temperature (highest/lowest) | Pearson Correlation Value | −0.045 |
| | Significance (p-value) | 0.000 |

For each group of historical weather metrics 142, up to n of the most significant historical weather metrics 142 are selected. Specifically, for Group A in step 220, the n_{A} historical weather metrics 142 with the highest absolute Pearson correlation coefficient are selected, provided there are n_{A} historical weather metrics 142 with a statistical significance within a predetermined threshold. (The predetermined threshold may be, for example, p≤0.05 or more preferably p≤0.01 or most preferably p≤0.001). Similarly, for Group B in step 221, the n_{B} historical weather metrics 142 with the highest absolute Pearson correlation coefficient are selected (provided there are n_{B} historical weather metrics 142 with a statistical significance within the predetermined threshold). A similar selection process is performed in steps 222 through 229 to select up to n_{C} metrics from Group C, select up to n_{D} metrics from Group D, etc., and to select up to n_{J} metrics from Group J.

Referring back to the example in Table 3, if the number n_{A} of historical weather metrics 142 selected from Group A is two, then the economic forecast engine 180 would select highest temperature departure from normal and average daily temperature departure from normal in order to build the statistical model.

The number of historical weather metrics n selected from each group may vary from group to group. Using the specific ten groups of the historical weather metrics 142 described above, in the most preferred embodiment, the economic forecast engine 180 selects the two most significant temperature metrics (Group 1), the two most significant dew point, relative humidity, soil temperature and moisture metrics (Group 2), the one most statistically significant atmospheric pressure metric (Group 3), the two most statistically significant cooling, heating, effective, growing, and freezing degree days metrics (Group 4), the two most statistically significant wind metrics (Group 5), the one most statistically significant solar irradiance metric (Group 6), the two most statistically significant sunshine metrics (Group 7), the two most statistically significant precipitation metrics (Group 8), the three most statistically significant snow, freeze, ice, and sleet metrics (Group 9), and the three most statistically significant tropical storms, hurricane, and visibility metrics (Group 10).

As described above, the economic forecast engine 180 uses the selected historical weather metrics 142 from all of the groups (in the most preferred embodiment, the 20 most statically significant historical weather metrics 142 with respect to the economic performance metric 122 of interest) and generates a statistical model to forecast the economic performance metric 122 of interest.

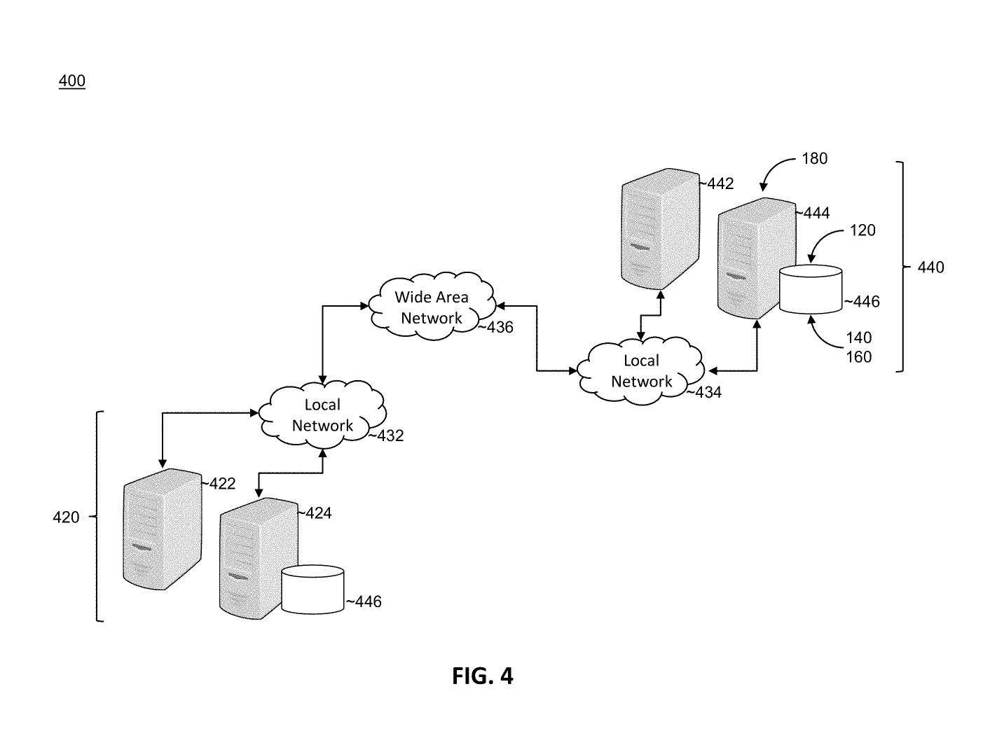

FIG. 4 is a block diagram of an architecture 400 of the economic forecasting system 100 according to an exemplary embodiment.

As shown in FIG. 4, the architecture 400 may include one or more client-side devices 420 that communicate, for example, via one or more client-side networks 432, and one or more server-side devices 440 that communicate, for example, via one or more server-side networks 434. The client-side devices 420 may communicate with the server-side devices via a wide area network 436, such as the internet. The client-side devices 420 may include one or more client computers 422, 424, etc., as well as non-transitory computer readable storage media 426. The server-side devices 440 may include one or more servers 442, 444, etc., as well as non-transitory computer readable storage media 446.

Each of the client computers 422, 424, etc. may be any suitable hardware computing device configured to send and/or receive data via the networks 432, 436, etc. Each of the client computers 422, 424, etc., may be, for example, a network-connected computing device such as a server, a personal computer, a notebook computer, a smartphone, a personal digital assistant (PDA), a tablet, network-connected vehicle, etc. Each of the client computers includes an internal storage device and a hardware processor, such as a central processing unit (CPU). Some or all of the client computers 422, 424, etc., may include output devices, such as a display, and input devices, such as a keyboard, mouse, touchpad, etc. Each of the one or more servers 442, 444, etc., may be any suitable hardware computing device configured to send and/or receive data via the networks 434, 436, etc. Each of the one or more servers 442, 444, etc., may be for example, an application server and a web server which hosts websites accessible by the client-side computing devices 420. Each of the one or more servers 442, 444, etc., include an internal non-transitory storage device and at least one hardware computer processor. Each non-transitory computer-readable storage media 426 and 446 may include hard disks, solid-state memory, etc. The one or more networks 432, 434, 436, etc., may include any combination of the internet, cellular networks, wide area networks (WAN), local area networks (LAN), etc. Communication via the network(s) 432, 434, 436, etc., may be realized by wired and/or wireless connections.

Referring back to FIG. 1, the economic forecasting system 100 includes the economic performance database 120, the historical weather database 140, the weather forecast database 160, and the economic forecast engine 180. The economic forecast engine 180 may be realized by software instructions executed by a hardware computer processor. The economic forecast engine 180 may be realized by software instructions executed by one of the servers 442, 444, etc. (on the server side) and/or the one of the client computers 422, 424 (on the client side). Similarly, the economic performance database 120, the historical weather database 140, and the weather forecast database 160 may be stored on the non-transitory computer readable storage media 446 (on the server side 440) and/or the non-transitory computer readable storage media 426 (on the client side 420).

In the architecture 400 illustrated in FIG. 4, the economic forecast engine 180 is realized by software instructions executed by one of the servers 442, 444, etc. (on the server side) and the economic performance database 120, the historical weather database 140, and the weather forecast database 160 are stored on the non-transitory computer readable storage media 446 (on the server side 440). However, the economic performance metrics 122 along with the locations 124 and times 126 associated with the economic performance metrics 122 may be received from the one or more client computers 422, 424, etc. (on the client side 420). In this embodiment, the economic forecast engine 180 may output the forecast for each economic performance metric 122 of interest to the server-side network 434 for transmittal to one or more of the client computers 422 or 424 via the wide area network 436. The client computers 422, 424, etc., may output the forecast to a user via a graphical user interface.

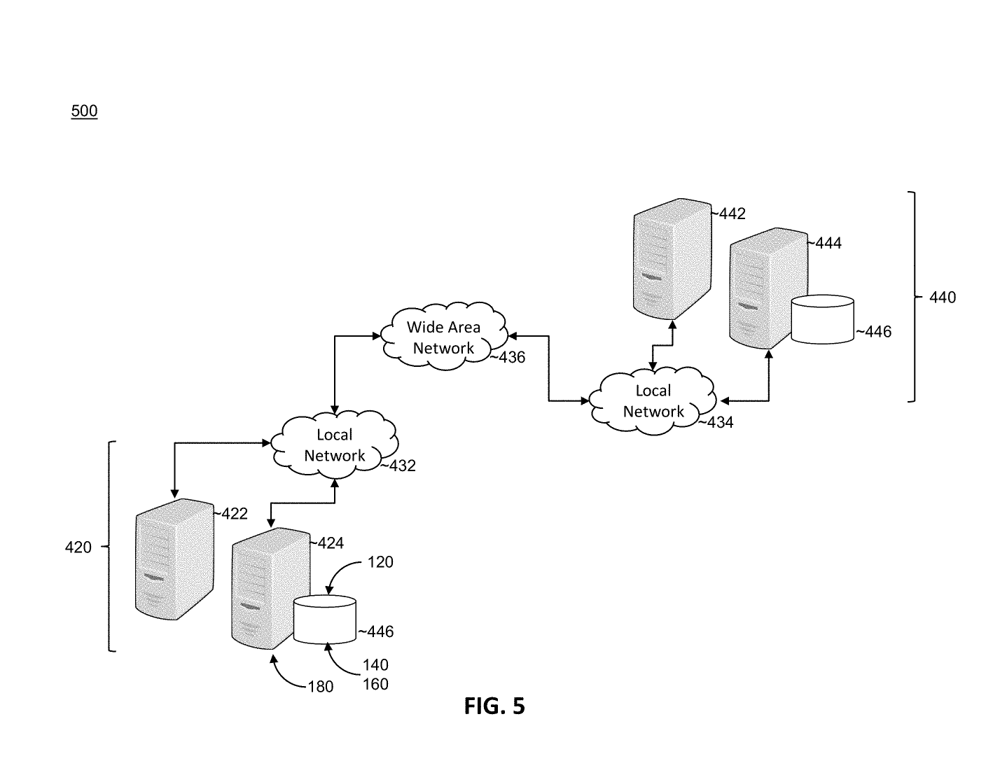

FIG. 5 is a block diagram of another architecture 500 of the economic forecasting system 100 according to another exemplary embodiment.

The architecture 500 illustrated in FIG. 5 is similar to the architecture 400 illustrated in FIG. 4, except that the economic forecast engine 180 is realized by software instructions executed by one of the client computers 422, 424, etc. (on the client side 420) and the economic performance database 120, the historical weather database 140, and the weather forecast database 160 are stored on the non-transitory computer readable storage media 426 (on the client side 420). In this embodiment, the historical weather metrics 142 (along with the locations 144 and times 146 associated with the historical weather metrics 142) as well as the forecasted weather metrics 162 (along with the locations 164 and times 166 associated with the historical weather metrics 162) may be received from the one or more servers 442, 444, etc. (on the server side 440). In this embodiment, the economic forecast engine 180 may output the forecast for each economic performance metric 122 of interest to a user via a graphical user interface.

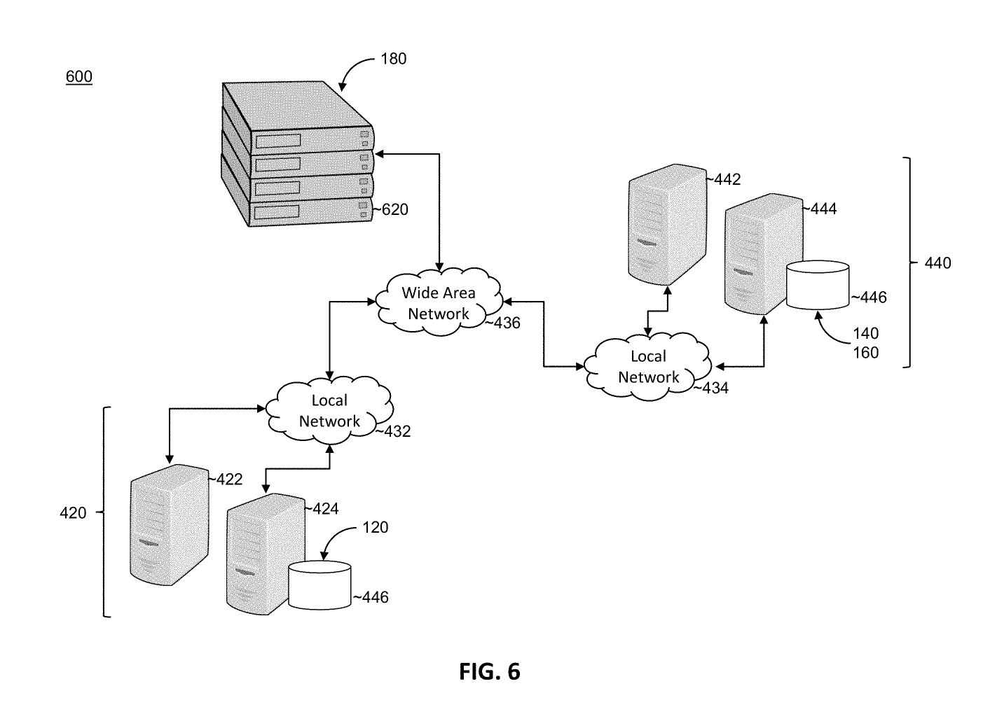

FIG. 6 is a block diagram of another architecture 600 of the economic forecasting system 100 according to another exemplary embodiment.

The architecture 600 illustrated in FIG. 5 is similar to the architecture 400 illustrated in FIG. 4, except that it also includes a cloud computing platform 620, such as a machine learning or other artificial intelligence platform. The cloud computing platform 620 may be, for example, the Microsoft Azure machine learning environment. In this embodiment, the economic forecast engine 180 is realized by software instructions executed by the cloud computing platform 620. Similar to the architecture 400 and the architecture 500, the economic performance database 120, the historical weather database 140, and the weather forecast database 160 may be stored on the non-transitory computer readable storage media 446 (on the server side 440) and/or the non-transitory computer readable storage media 426 (on the client side 420).

Since the currently available weather database has over 300 historical weather metrics 142, the dimensional reduction process described above allows the economic forecasting system 100 to uncover significant metrics 142 that may potentially be lost when tested with all metrics together (as may be done with convention economic forecasting systems), improving the accuracy of the statistical model used to forecast the economic performance metric 122 of interest. As an example, when wind speed, temperature, and humidity are tested together, temperature and humidity may be statistically significant due to their strong interaction, which overshadows the effect of wind speed on the economic performance metric 122 of interest. However, when the economic forecasting system 100 tests wind speed in conjunction with other wind speed metrics as described above, the economic forecasting system 100 has found that the highest sustained wind speed and wind gust speed are statistically significant with certain economic performance metrics 122.

The economic forecasting system 100 generates highly accurate forecasts of economic trends by decreasing the number of historical weather metrics 142 into a more manageable set, without sacrificing the accuracy of future models, and performing analytical processes with the most statistically significant historical weather metrics 142 from each group. The disclosed economic forecasting system 100 also provides repeatable results for the user for performing a variety of analytical projects.

In general, the large amount of historical weather metrics 142 available for testing are computationally expensive to test. By testing the historical weather metrics 142 in separate groups (and later combining the most statistically significant historical weather metrics 142 from each of the groups to generate a statistical model), the economic forecasting system 100 is able to efficiently determine which of the historical weather metrics 142 from each group have a significant relationship with the economic performance metric 122 of interest.

The economic forecasting system 100 is also able to provide clients with the most accurate insights and forecasts of economic trends so that they can utilize forecasted weather metrics 162 to capture future sales lifting events and minimize sales depressing events. The economic forecasting system 100 allows for more effective planning and increased sales across all product lines and geographical regions.

The economic forecasting system 100 overcomes a technical problem with conventional economic forecasting systems that may analyze historical weather metrics 142 together and therefore generate underfitted and/or overfitted statistical models, in part due to the high multicollinearity of historical weather metrics 142. By analyzing historical weather metrics 142 together, a conventional economic forecasting system may generate an underfitted statistical model that forecasts an economic performance metric 122 of interest as a function of only the following five historical weather metrics 142:
Minutes of sunshine possible
Percent of sunshine calculated
Snow at 0.50 inches
Snow on the ground
Total water equivalent

By contrast, the economic forecasting system 100, using the dimension reduction process described above, is able to identify historical weather metrics 142 that have a more subtle relationship with the economic performance metric 122 of interest, which are lost when historical weather metrics 142 are analyzed together. Accordingly, the economic forecasting system 100 using the dimension reduction process described above generates a statistical model that forecasts an economic performance metric 122 of interest as a function of the following 13 historical weather metrics 142:
Average wind speed
Maximum wet bulb temperature
Minimum relative humidity
Minimum sustained wind speed
Minutes of sunshine possible
Percent of sunshine calculated
Snow at 0.50 inches
Snow on the ground
Snow within 35 miles
Soil moisture
Total water equivalent
Visibility at 0.50 miles
Visibility at 2.00 miles

While preferred embodiments have been set forth above, those skilled in the art who have reviewed the present disclosure will readily appreciate that other embodiments can be realized within the scope of the invention. For example, disclosures of specific numbers of hardware components, software modules and the like are illustrative rather than limiting. Therefore, the present invention should be construed as limited only by the appended claims.

1. A system for forecasting an economic performance metric of interest, the system comprising:
a historical economic performance database that stores one or more geo-located and time-indexed historical economic performance metrics including the economic performance metric of interest;
a historical weather database that stores geo-located and time-indexed historical weather metrics, wherein the historical weather metrics are separated into groups such that the historical weather metrics with high multicollinearity are grouped together;
a weather forecast database that stores geo-located and time-indexed forecasted weather metrics; and
an economic forecast engine that:
performs a correlation analysis to identify the correlation and statistical significance of each of the historical weather metrics with respect to the economic performance metric of interest;
selects up to a predetermined number of historical weather metrics from each group with the highest correlation with respect to the economic performance metric of interest and a statistical significance meeting or exceeding a predetermined threshold;
generates a statistical model to forecast the economic performance metric of interest using the selected historical weather metrics from all of the groups;
forecasts the economic performance metric of interest using the statistical model and the forecasted weather metrics; and
outputs the forecasted economic performance metric of interest for display to a user.

2. The system of claim 1, wherein the economic forecast engine generates the statistical model using regression analysis.

3. The system of claim 1, wherein the economic forecast engine generates the statistical model using decision trees.

4. The system of claim 1, wherein the economic forecast engine generates the statistical model using a neural network.

5. The system of claim 1, wherein the historical weather metrics are separated into groups such that the historical weather metrics with the highest absolute Pearson correlation coefficient with respect to each other are in the same group.

6. The system of claim 1, wherein the economic forecast engine selects up to the predetermined number of historical weather metrics from each group with the highest absolute Pearson correlation coefficient with respect to the economic performance metric of interest.

7. The system of claim 1, wherein:
the groups comprise a first group and a second group;
the economic forecast engine selects up to a first predetermined number of historical weather metrics from the first group and up to a second first predetermined number of historical weather metrics from the first group; and
the first predetermined number is different than the second predetermined number.

8. The system of claim 1, wherein the predetermined threshold for statistical significance is a probability value less than or equal to 0.05.

9. The system of claim 1, wherein the groups of weather metrics include temperature metrics, dew point, relative humidity, soil temperature and moisture metrics, atmospheric pressure metrics, cooling, heating, effective, growing, and freezing degree days metrics, wind metrics, solar irradiance metrics, sunshine metrics, precipitation metrics, snow, freeze, ice, and sleet metrics, and spring, tropical storms, hurricane, and visibility metrics.

10. The system of claim 9, wherein the economic forecast engine selects up two temperature metrics, up to two dew point, relative humidity, soil temperature and moisture metrics, up to one atmospheric pressure metric, up to two cooling, heating, effective, growing, and freezing degree days metrics, up to two wind metrics, up to one solar irradiance metric, up to two sunshine metrics, up to two precipitation metrics, up to three snow, freeze, ice, and sleet metrics, and up to three tropical storm, hurricane, and visibility metrics.

11. A method for forecasting an economic performance metric of interest based on geo-located and time-indexed historical weather metrics, wherein the historical weather metrics are separated into groups such that the historical weather metrics with high multicollinearity are grouped together, the method comprising:
receiving one or more geo-located and time-indexed historical economic performance metrics including the economic performance metric of interest;
receiving geo-located and time-indexed forecasted weather metrics;
performing a correlation analysis to identify the correlation and statistical significance of each of the historical weather metrics with respect to the economic performance metric of interest;
selecting up to a predetermined number of historical weather metrics from each group with the highest correlation with respect to the economic performance metric of interest and a statistical significance meeting or exceeding a predetermined threshold;
generating a statistical model to forecast the economic performance metric of interest using the selected historical weather metrics from all of the groups;
forecasting the economic performance metric of interest using the statistical model and the forecasted weather metrics; and
outputting the forecasted economic performance metric of interest for display to a user.

12. The method of claim 11, wherein the statistical model is generated using regression analysis.

13. The method of claim 11, wherein the statistical model is generated using decision trees.

14. The method of claim 11, wherein the statistical model is generated using a neural network.

15. The method of claim 11, wherein the historical weather metrics are separated into groups such that the historical weather metrics with the highest absolute Pearson correlation coefficient with respect to each other are in the same group.

16. The method of claim 11, wherein the predetermined number of historical weather metrics from each group with the highest absolute Pearson correlation coefficient with respect to the economic performance metric of interest are selected.

17. The method of claim 11, wherein:
the groups comprise a first group and a second group;
a first predetermined number of historical weather metrics are selected from the first group and up to a second first predetermined number of historical weather metrics are selected from the first group; and
the first predetermined number is different than the second predetermined number.

18. The method of claim 11, wherein the predetermined threshold for statistical significance is a probability value less than or equal to 0.05.

19. The method of claim 11, wherein the groups of weather metrics include temperature metrics, dew point, relative humidity, soil temperature and moisture metrics, atmospheric pressure metrics, cooling, heating, effective, growing, and freezing degree days metrics, wind metrics, solar irradiance metrics, sunshine metrics, precipitation metrics, snow, freeze, ice, and sleet metrics, and spring, tropical storms, hurricane, and visibility metrics.

20. The method of claim 19, wherein up two temperature metrics, up to two dew point, relative humidity, soil temperature and moisture metrics, up to one atmospheric pressure metric, up to two cooling, heating, effective, growing, and freezing degree days metrics, up to two wind metrics, up to one solar irradiance metric, up to two sunshine metrics, up to two precipitation metrics, up to three snow, freeze, ice, and sleet metrics, and up to three tropical storm, hurricane, and visibility metrics are selected.

21. A non-transitory computer readable storage medium storing instructions that, when executed by a computer processor, cause the computer processor to forecast an economic performance metric of interest based on geo-located and time-indexed historical weather metrics, wherein the historical weather metrics are separated into groups such that the historical weather metrics with high multicollinearity are grouped together, the instructions causing the computer to perform a process comprising:
receive one or more geo-located and time-indexed historical economic performance metrics including the economic performance metric of interest;
receive geo-located and time-indexed forecasted weather metrics;
perform a correlation analysis to identify the correlation and statistical significance of each of the historical weather metrics with respect to the economic performance metric of interest;
select up to a predetermined number of historical weather metrics from each group with the highest correlation with respect to the economic performance metric of interest and a statistical significance meeting or exceeding a predetermined threshold;
generate a statistical model to forecast the economic performance metric of interest using the selected historical weather metrics from all of the groups;
forecast the economic performance metric of interest using the statistical model and the forecasted weather metrics; and
output the forecasted economic performance metric of interest for display to a user.
